(19) United States
(12) Patent Application Publication
(10) Pub. No.: US 2011/0193292 A1
(43) Pub. Date: Aug. 11, 2011

(54) MAGNETIC FLUID SEALING AND PACKING RING SEALING DEVICE FOR RECIPROCATING SHAFT WITH THE PACKING RING HAVING THREE OBLIQUE MOUTHS

(75) Inventors: Decai Li, Beijing (CN); Jishang Wang, Beijing (CN)

(73) Assignee: Beijing Jiaotong University

(21) Appl. No.: 12/987,270

(22) Filed: Jan. 10, 2011

(30) Foreign Application Priority Data
Feb. 11, 2010 (CN) 201010111848.3

(51) Int. Cl. F16J 15/43

(52) U.S. Cl. 277/410

(57) ABSTRACT

A magnetic fluid sealing and packing ring sealing device for reciprocating shaft with the packing ring having three oblique mouths, characterized in that the first packing ring (2) with three oblique mouths, the first pole piece (3) with “O” rubber seal ring, the first permanent magnet (4), the second pole piece (5) with “O” rubber seal ring, the second packing ring (6) with three oblique mouths, the third pole piece (7) with “O” rubber seal ring, the second permanent magnet (8), the fourth pole piece (9) with “O” rubber seal ring, the third packing ring (10) with three oblique mouths, the fifth pole piece (11) with “O” rubber seal ring, the third permanent magnet (12), the sixth pole piece (13) with “O” rubber seal ring, the fourth packing ring (14) with three oblique mouths are placed at the end of sealed chamber (1) with “O” rubber seal ring in order, the sealed chamber (1) with “O” rubber seal ring is connected by the bolt (16) to press the above parts tightly. Before the reciprocating shaft seal device is applied, the magnetic fluid has been injected underneath the teeth of pole piece with “O” rubber seal ring. The problem of leakage of reciprocating compressor can be solved.

### FIELD OF THE PRESENT INVENTION

The present invention is related to the field of sealing in mechanical engineering, especially to a reciprocating motion sealing for shaft of vacuum coating machines, compressors and so on when the temperature is belo 150° and the sealing medium is the gas.

### BACKGROUND OF THE PRESENT INVENTION

Compressor is general machinery which is used to compress gases to increase pressure or transport gases. The most widely used compressor is type of reciprocating, screw and centrifugal. The reciprocating compressor has such advantages as high efficiency and high pressure, so it can be widely used in mining, metallurgy, petroleum, chemical industry and so on. However, the leakage of reciprocating compressor is a common phenomenon, and because of its wide range of applications, the problem becomes more important to be solved. Especially, for compressing or transporting flammable, explosive, and poisonous gases, the leakage of compressor cannot be ignored. Current sealing methods of reciprocating compressor piston rod are packing seal and labyrinth seal. Packing seal is a contact seal, when the pressure is high, the compressor is easy to wear and low in using life; when the pressure is low, because of insufficient back pressure, the leakage of compressor is high. Labyrinth piston compressor demands very high precision on the manufacture, only a few companies in the world can produce it. Using the response characteristics of the magnetic field of magnetic fluid, the magnetic fluid is injected into the gap between the pole piece and the reciprocating shaft, then Liquid “O” sealing rings are formed on the surface of the shaft, thus playing a role in sealing. This kind of sealing method demands less precision on the surface of the shaft, and there is no contact between pole piece and the shaft, so the heat productivity is small. But the reciprocating motion of shaft takes away some magnetic fluid, and long time reciprocating motion makes the sealing fail as the amount of magnetic fluid in the sealing gap is reduced. So any single seal structures cannot solve the problem of leakage of reciprocating compressors.

### SUMMARY OF THE PRESENT INVENTION

The object of the present invention is to provide a reciprocating shaft sealing device by means of magnetic fluid and the packing ring with three oblique mouths, so as to solve the problem of leakage of reciprocating compressors when any single sealing cannot meet the sealing requirements currently.

Technical solution of the invention is as follows.

A reciprocating shaft sealing device by means of magnetic fluid and the packing ring with three oblique mouths, characterized in that the first packing ring with three oblique mouths, the first pole piece with “O” rubber seal ring, the first permanent magnet, the second pole piece with “O” rubber seal ring, the second packing ring with three oblique mouths, the third pole piece with “O” rubber seal ring, the second permanent magnet, the fourth pole piece with “O” rubber seal ring, the third packing ring with three oblique mouths, the fifth pole piece with “O” rubber seal ring, the third permanent magnet, the sixth pole piece with “O” rubber seal ring, the fourth packing ring with three oblique mouths are placed at the end of a sealed chamber with “O” rubber seal ring in order, by the threaded connection between holes of the end cover that the bolt goes through and sealed chamber with “O” rubber seal ring, making the end cover press parts tightly.

Before the reciprocating shaft sealing device that put magnetic fluid and the packing ring with three oblique mouths together is installed on the shaft, a magnetic fluid has been injected underneath the teeth of pole piece from one to six.

Three water inlets and outlets are set up on the sealed chamber with “O” rubber seal ring as mentioned above; the distance between the centerline of the first water inlet or outlet and the bottom of seal chamber is l₁+l₂+l₃+l₄+l₅, in which l₁+l₂ is the thickness of the packing ring with three oblique mouths, l₃ is the hole depth of the first pole piece with “O” rubber seal ring, l₄ is the thickness of the first permanent magnet, and l₅ is the distance between the centerline of cooling trough of the second pole piece with “O” rubber seal ring and the end face of the right counter bore.

The distance from centerline of the middle water inlet or outlet to centerline of the first water inlet or outlet is l₂+l₃+l₄+l₅+l₆, and the distance from centerline of the left water inlet or outlet to centerline of the middle water inlet or outlet is also l₂+l₃+l₄+l₅+l₆, in which l₆ is the distance from the centerline of cooling trough of the second pole piece with “O” rubber seal ring to the left end face of the second pole piece with “O” rubber seal ring.

The cooling annular trough is set up on the second pole piece with “O” rubber seal ring, the fourth pole piece with “O” rubber seal ring, and the sixth pole piece with “O” rubber seal ring as mentioned above.

In the parameters of tooth shape of pole piece with “O” rubber seal ring as mentioned above, the face width is 0.2 mm, the alveolar width is 2.8 mm, and the alveolus dip angle between the outer edge generatrix of the pole teeth and the tilt part of the alveolus is 4°.

The carrier fluid of magnetic fluid as mentioned above is kerosene, and the diameter of magnetic particle is less than 5 nm.

With the beneficial effects of the invention, the applied reciprocating shaft sealing device that puts magnetic fluid and the packing ring with three oblique mouths together solves the problem of leakage of reciprocating compressors. The function of the Drilled packing ring in the magnetic fluid and the packing ring combined sealing device is to prevent the magnetic fluid removing and the deformation of reciprocating shaft, in which the magnetic fluid seal also plays the important role of seal pressure, so the lifetime of this device is long and the surface temperature of shaft is low.

### DESCRIPTION OF THE ACCOMPANYING DRAWINGS

FIG. 1 is a schematic structural view of the reciprocating shaft sealing device that puts magnetic fluid and the packing ring with three oblique mouths together.

FIG. 2 is a sectional view of the end cover.

FIG. 3 is sectional drawing of the second, fourth, sixth pole pieces with “O” rubber seal ring.

FIG. 4 is a partially enlargement view of the device.

FIG. 5 is the sectional view of the third and fifth pole pieces with “O” rubber seal ring.

FIG. 6 is a sectional view of the first pole piece with “O” rubber seal ring.

FIG. 7 is a sectional view of the sealed chamber.

FIG. 8 is a the left view of the sealed chamber.

In the figures, there show the sealed chamber 1 with “O” rubber seal ring, the first packing ring 2 with three oblique mouths, the first pole piece 3 with “O” rubber seal ring, the first permanent magnet 4, the second pole piece 5 with “O” rubber seal ring, the second packing ring 6 with three oblique mouths, the third pole piece 7 with “O” rubber seal ring, the second permanent magnet 8, the fourth pole piece 9 with “O” rubber seal ring, the third packing ring 13 with three oblique mouths, the fifth pole piece 11 with “O” rubber seal ring, the third permanent magnet 12, the sixth pole piece 13 with “O” rubber seal ring, the fourth packing ring 14 with three oblique mouths, the end cover 15 with “O” rubber seal ring, and the bolt 16.

### PREFERRED EMBODIMENTS TO CARRY OUT THE PRESENT INVENTION

A further explanation of embodiments of this invention is made with the attached drawings.

A reciprocating shaft sealing device that puts magnetic fluid and the packing ring with three oblique mouths together is characterized in that the first packing ring 2 with three oblique mouths, the first pole piece 3 with “O” rubber seal ring, the first permanent magnet 4, the second pole piece 5 with “O” rubber seal ring, the second packing ring 6 with three oblique mouths, the third pole piece 7 with “O” rubber seal ring, the second permanent magnet 8, the fourth pole piece 9 with “O” rubber seal ring, the third packing ring 10 with three oblique mouths, the fifth pole piece 11 with “O” rubber seal ring, the third permanent magnet 12, the sixth pole piece 13 with “O” rubber seal ring, the fourth packing ring 14 with three oblique mouths are placed at the end of sealed chamber 1 with “O” rubber seal ring in order, by the threaded connection between holes of the end cover 15 that the bolt 16 goes through and sealed chamber 1 with “O” rubber seal ring, making the end cover 15 press parts tightly.

Before the reciprocating shaft sealing device that puts magnetic fluid and the packing ring with three oblique mouths together is installed on the shaft, the magnetic fluid has been injected underneath the teeth of pole piece with “O” rubber seal ring from one to six.

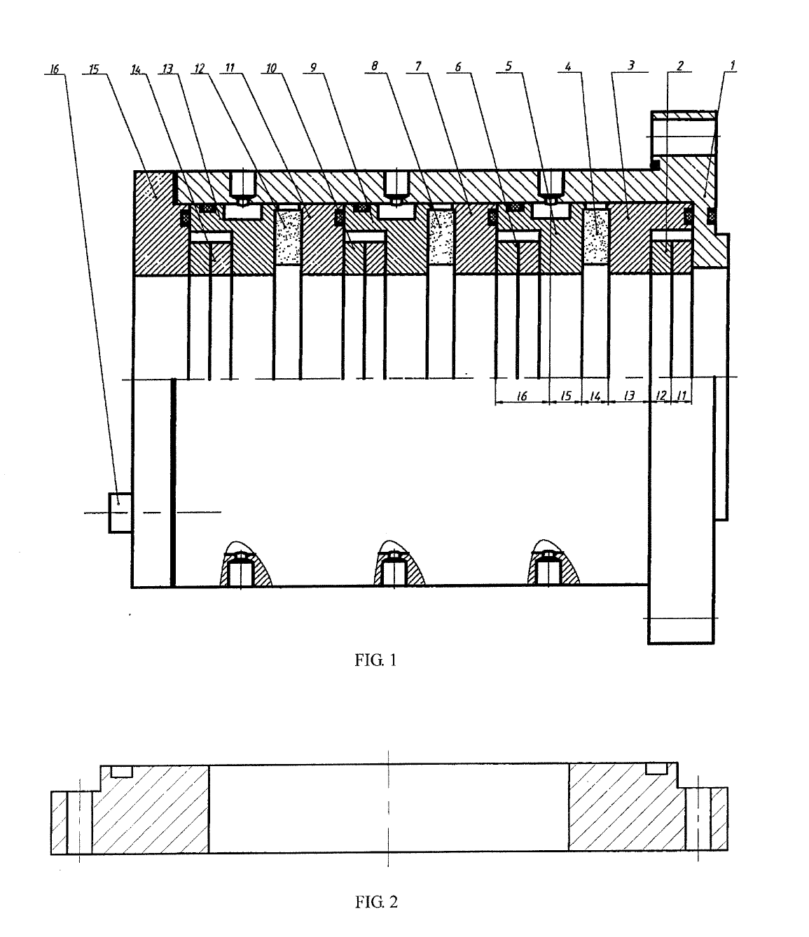

As shown in the FIGS. 1, 7, and 8, two sides of flanges of the sealed chamber 1 with “O” rubber seal ring are designed to have a seal groove in which the “O” rubber seal ring are placed; Four through holes and four threaded hole are laid out evenly on the flange and the left end plane, which are used to connect with the internal face of seal cavity and the end cover 15 with “O” rubber seal ring, respectively.

Three water inlets and outlets are set up radially and symmetrically on the wall of the sealed chamber; the distance between the centerline of the first water inlet or outlet and the bottom of seal chamber is l₁+l₂+l₃+l₄+l₅, in which l₁+l₂ is the thickness of the packing ring 2 with three oblique mouths, l₄ is the hole depth of the first pole piece 3 with “O” rubber seal ring is l₃ is the thickness of the first permanent magnet 4, and l₅ is the distance between the centerline of cooling trough of the second pole piece 5 with “O” rubber seal ring and the end face of the right counter bore.

The distance from centerline of the middle water inlet or outlet to centerline of the first water inlet or outlet is l₂+l₃+l₄+l₅+l₆. The distance from centerline of the left water inlet or outlet to centerline of the middle water inlet or outlet is also l₂+l₃+l₄+l₅+l₆, in which l₆ is the distance from the centerline of cooling trough of the second pole piece 5 with “O” rubber seal ring to the left end face of the second pole piece 5 with “O” rubber seal ring.

The cooling annular trough is set up on the second pole piece 5 with “O” rubber seal ring, the fourth pole piece 9 with “O” rubber seal ring, and the sixth pole piece 13 with “O” rubber seal ring.

As shown in the FIG. 4, on the parameters of tooth form of pole piece from one to six with “O” rubber seal ring, the face width is 0.2 mm, the alveolar width is 2.8 mm, and the alveolus dip angle between the outer edge generatrix of the pole teeth and the tilt part of the alveolus is 4°.

The structure and size of the packing rings 2, 6, 10, and 14 with three oblique mouths are the same as one another.

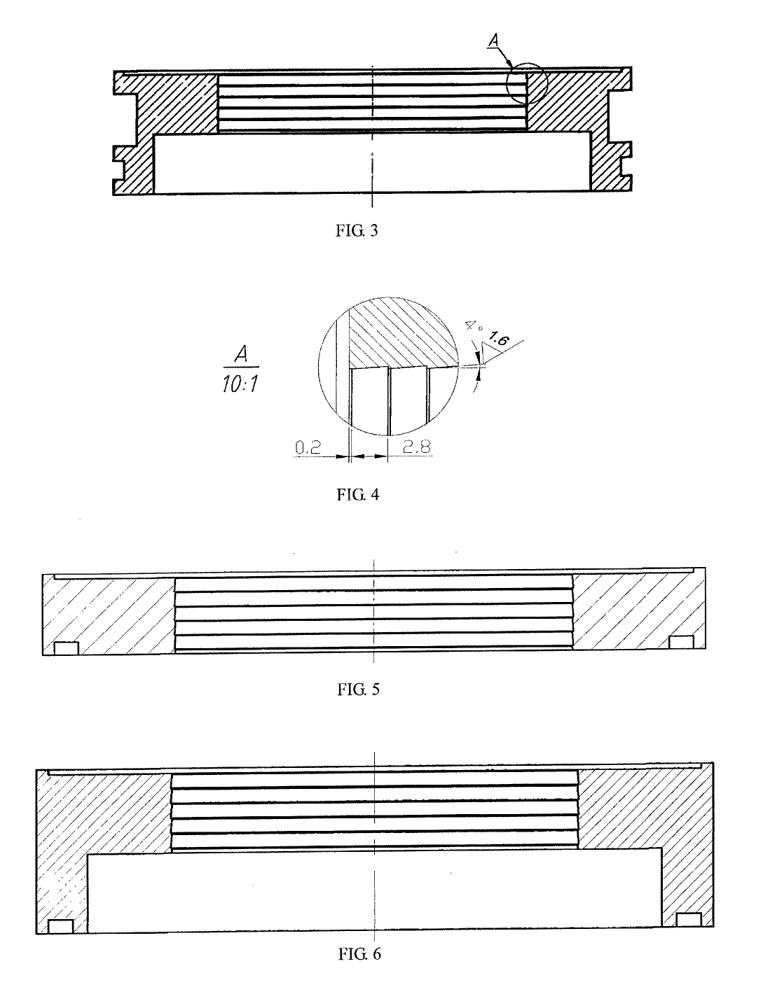

As shown in FIG. 3, the structure and size of the second, fourth, sixth pole pieces with “O” rubber seal ring are the same as one another. The cooling trough and seal groove are set up on the outer annulus of pole piece, and the “O” rubber seal ring is placed in the seal groove. The teeth of pole piece are processed on the annulus of small endoporus.

As shown in FIG. 5, the structure and size of both the third and the fifth pole piece with the “O” rubber seal ring are the same as one another. The seal groove is set up on the right end face of the pole piece and the “O” rubber seal ring is placed in the seal groove. The teeth of pole piece are processed on the annulus of the endoporus.

As shown in FIG. 2, the seal groove is set up on the right end face of the end cover 15 in which the “O” rubber seal ring is placed. As shown in FIG. 1, the “O” rubber seal ring is placed in the seal groove.

The interior diameter of the end cover 15 from the first pole piece to sixth pole piece with the “O” rubber seal ring and that from the first packing ring to fourth packing ring with three oblique mouths are the same as each other.

As shown in FIG. 6, it is the pole piece 3 with the “O” rubber seal ring. The seal groove is set up on the end face of the pole piece 3 with the “O” rubber seal ring in which the “O” rubber seal ring is placed, as shown in FIG. 1. The teeth of pole piece are processed on the annulus of small endoporus.

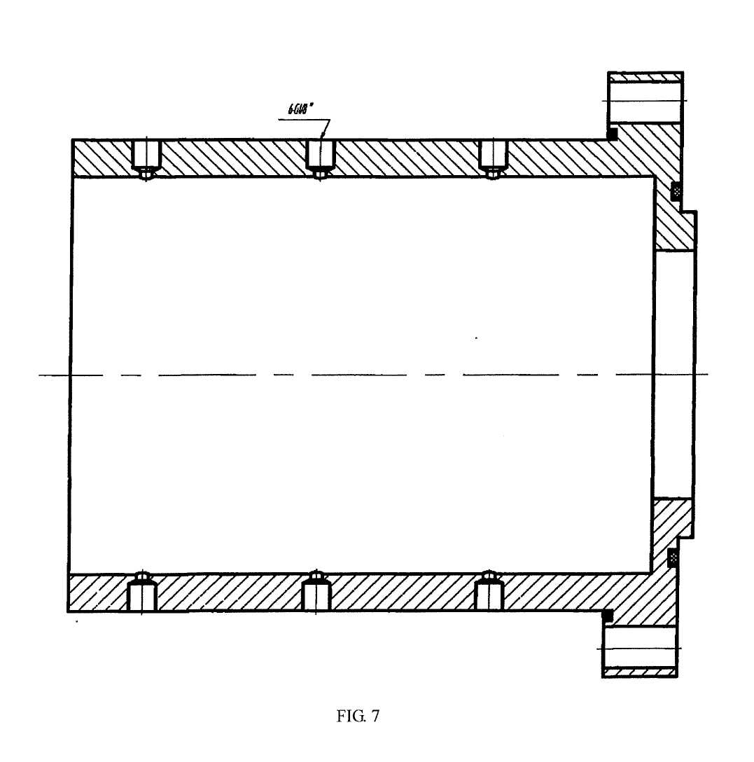

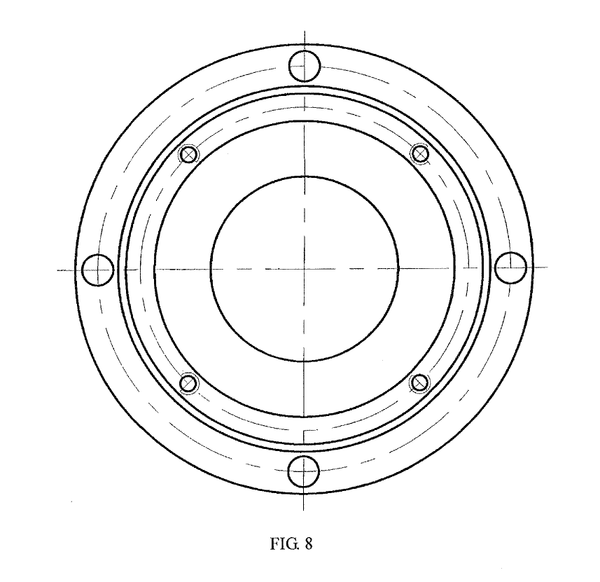

As shown in FIGS. 1 and 7, it is the sealed chamber 1 with the “O” rubber seal ring. The seal groove is set up on the two sides of flanges of the sealed chamber 1 in which the “O” rubber seal ring is placed.

All “O” shaped seal ring is made of Viton; the first to third Permanent magnet is made of Nd—Fe—B; and the first to sixth pole piece with “O” rubber seal ring is made of DT3.

As an example, the sealing device of the invention is used to seal the reciprocating shaft whose diameter is 80 mm. Each pole piece has 5 teeth, and the thickness of the seal gap is 0.2 mm, and the alveolar width is 2.5 mm. Permanent magnet is made of Nd—Fe—B. The packing ring with three oblique is made of PTFE. Kerosene-base magnetic fluid is adopted. The effect of seal is quite obvious when the stroke of the reciprocating shaft is 280 mm and the running speed of the crank is 192 r/min.

1. A magnetic fluid sealing and packing ring sealing device for reciprocating shaft with the packing ring having three oblique mouths, characterized in that the first packing ring (2) with three oblique mouths, the first pole piece (3) with “O” rubber seal ring, the first permanent magnet (4), the second pole piece (5) with “O” rubber seal ring, the second packing ring (6) with three oblique mouths, the third pole piece (7) with “O” rubber seal ring, the second permanent magnet (8), the fourth pole piece (9) with “O” rubber seal ring, the third packing ring (10) with three oblique mouths, the fifth pole piece (11) with “O” rubber seal ring, the third permanent magnet (12), the sixth pole piece (13) with “O” rubber seal ring, the fourth packing ring (14) with three oblique mouths are placed at the end of sealed chamber (1) with “O” rubber seal ring in order, the end cover (15) in which a hole is provided to go through is connected to the sealed chamber (1) with “O” rubber seal ring by the bolt (16), making the end cover (15) press above listed parts tightly,
before the magnetic fluid sealing and packing ring sealing device for reciprocating shaft with the packing ring having three oblique mouths is installed on the shaft, the magnetic fluid is injected underneath the teeth of first to sixth pole pieces with “O” rubber seal ring.

2. A magnetic fluid sealing and packing ring sealing device for reciprocating shaft with the packing ring having three oblique mouths according to claim 1, characterized in that three water inlets and outlets are set up on the sealed chamber (1) with “O” rubber seal ring; the distance between the centerline of the first water inlet or outlet and the bottom of seal chamber is l₁+l₂+l₃+l₄+l₅, in which l₁+l₂ is the thickness of the packing ring (2) with three oblique mouths, l₃ is the hole depth of the first pole piece (3) with “O” rubber seal ring, l₄ is the thickness of the first permanent magnet (4), and l₅ is the distance between the centerline of cooling trough of the second pole piece (5) with “O” rubber seal ring and the end face of the right counter bore,
the distance from centerline of the middle water inlet or outlet to centerline of the first water inlet or outlet is l₂+l₃+l₄+l₅+l₆, and the distance from centerline of the left water inlet or outlet to centerline of the middle water inlet or outlet is also l₂+l₃+l₄+l₅+l₆, in which l₆ is the distance from the centerline of cooling trough of the second pole piece (5) with “O” rubber seal ring to the left end face of the second pole piece (5) with “O” rubber seal ring.

3. A magnetic fluid sealing and packing ring sealing device for reciprocating shaft with the packing ring having three oblique mouths according to claim 1, characterized in that the cooling annular trough is set up on the second pole piece (5) with “O” rubber seal ring, the fourth pole piece (9) with “O” rubber seal ring, and the sixth pole piece (13) with “O” rubber seal ring.

4. A magnetic fluid sealing and packing ring sealing device for reciprocating shaft with the packing ring having three oblique mouths according to claim 1, characterized in that in the parameters of tooth shape of pole piece with “O” rubber seal ring, the face width is 0.2 mm, the alveolar width is 2.8 mm, and the alveolus dip angle between the outer edge generatrix of the pole teeth and the tilt part of the alveolus is 4°.

5. A magnetic fluid sealing and packing ring sealing device for reciprocating shaft with the packing ring having three oblique mouths according to claim 1, characterized in that the carrier fluid of magnetic fluid is kerosene, and the diameter of magnetic particle is less than 5 nm.
